(19) United States
(12) Patent Application Publication
(10) Pub. No.: US 2008/0216338 A1
(43) Pub. Date: Sep. 11, 2008

(54) AIR BLADE

(76) Inventor: Dewey I. Doyle, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/043,390

(22) Filed: Mar. 6, 2008

Related U.S. Application Data
(60) Provisional application No. 60/893,236, filed on Mar. 6, 2007.

(51) Int. Cl. F26B 19/00

(52) U.S. Cl. 34/60; 34/443

(57) ABSTRACT

An air blade comprising a handle portion and a blade portion connected to the handle portion, with the blade portion including an elongated opening therein for blowing air out of the air blade onto an object. The air blade also includes a pair of projections located on each end of the elongated opening and extending outwardly in a direction of the blowing air leaving the air blade such that when the blade portion of the air blade is positioned to abut the object, the elongated opening will be spaced from the object.

### CROSS-REFERENCE TO RELATED APPLICATION

This application claims priority to U.S. Provisional Patent Application No. 60/893,236 filed on Mar. 6, 2007 and entitled AIR BLADE, the entire contents of which is hereby incorporated by reference.

### FIELD OF THE INVENTION

The present invention relates to a car wash system, and more particularly relates to a dryer for car wash systems.

### SUMMARY OF THE PRESENT INVENTION

An aspect of the present invention is to provide an air blade comprising a handle portion and a blade portion connected to the handle portion, with the blade portion including an elongated opening therein for blowing air out of the air blade onto an object. The air blade also includes a pair of projections located on each end of the elongated opening and extending outwardly in a direction of the blowing air leaving the air blade such that when the blade portion of the air blade is positioned to abut the object, the elongated opening will be spaced from the object.

Another aspect of the present invention is to provide an air blade comprising a handle portion and a blade portion connected to the handle portion, with the blade portion including an elongated opening therein for blowing air out of the air blade onto an object. The air blade also includes a pair of projections located on each end of the elongated opening and extending outwardly in a direction of the blowing air leaving the air blade such that when the blade portion of the air blade is positioned to abut the object, the elongated opening will be spaced from the object. The handle portion includes handle grip section and a fitting end, with the fitting end being configured to be connected to a hose and the handle grip section including a hollow cylinder with finger grooves on a bottom thereof. The handle grip portion includes a T-grip section allowing a user of the air blade to easily grasp the air blade during use. The blade portion includes a pair of side plates with the elongated opening in a bottom thereof between the side plates, with bottom ends of the side plates being angled towards each other to form a nozzle for the air blade.

Yet another aspect of the present invention is to provide a method of drying an object comprising providing an air blade comprising a handle portion and a blade portion connected to the handle portion, with the blade portion including an elongated opening therein, providing the air blade with a pair of projections located on each end of the elongated opening and extending outwardly, positioning the air blade adjacent the object, abutting the projections against the object, supplying air to the air blade, and blowing the air out of the elongated opening of the air blade and onto the object.

These and other aspects, objects, and features of the present invention will be understood and appreciated by those skilled in the art upon studying the following specification, claims, and appended drawings.

### BRIEF DESCRIPTION OF DRAWINGS

FIG. 1 is a view of an air blade of the present invention in a car wash.

FIG. 2 is perspective partially exploded view of the air blade of the present invention.

FIG. 2A is a close up view of a portion of the air blade of the present invention as shown in FIG. 2.

FIG. 3 is a bottom view of the air blade of the present invention.

FIG. 4 is an end view of the air blade of the present invention showing use of the air blade on a surface.

FIG. 5 is an end view of the air blade of the present invention showing use of the air blade on a surface as shown within circle V of FIG. 4.

FIG. 6 is a perspective exploded view of a second embodiment of the air blade of the present invention.

FIG. 7 is a broken side view of a third embodiment of the air blade of the present invention.

FIG. 8 is a close up view of another pad for use with the air blade of the present invention.

### DETAILED DESCRIPTION OF PREFERRED EMBODIMENTS

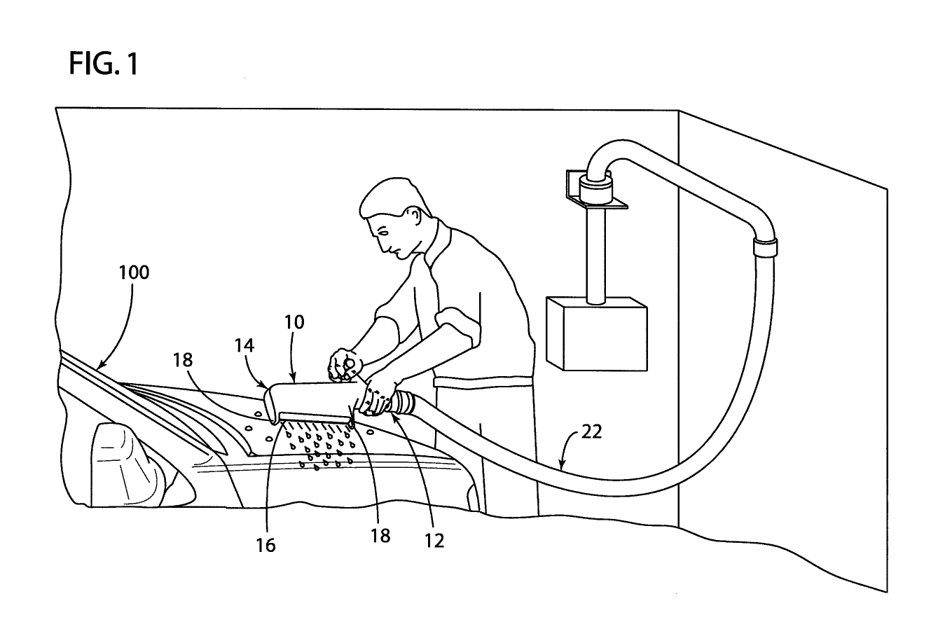

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIGS. 1-5) generally designates an air blade embodying the present invention. In the illustrated example, the air blade 10 comprises a handle portion 12 and a blade portion 14. The blade portion 14 includes an elongated opening 16 therein for blowing air out of the air blade 10 onto an object. A pair of projections 18 are located on each end 20 of the elongated opening 16 such that when the blade portion 14 of the air blade 10 is positioned to abut the object, the elongated opening 16 will be spaced from the object.

In the illustrated example, the air blade 10 is configured to be connected to a hose 22 for supplying forced air to the air blade 10. The hose 22 is typically made of a flexible material such that the hose, and therefore the air blade 10, can be bent and manipulated into several configurations and positions. The hose 22 can be connected to a source of air, such as that used in self serve car washes (see FIG. 1). Such self serve car washes are well known to those skilled in the art. Therefore, the air blade 10 can be used to dry vehicles 100 and floor carpets. However, it is contemplated that the air blade 10 could be used to dry any object in any location (e.g., on golf carts or windows).

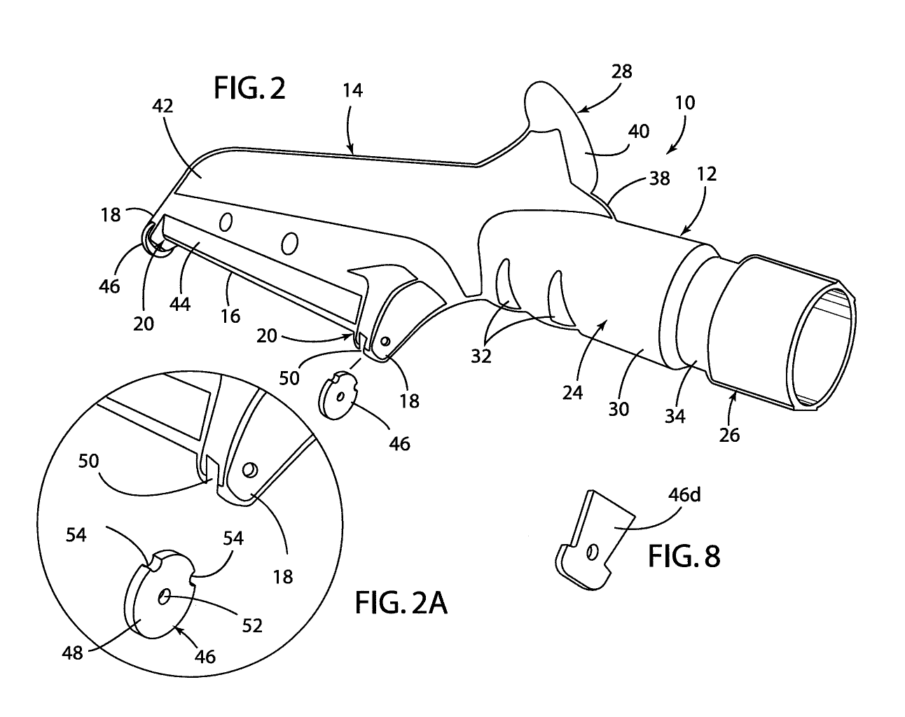

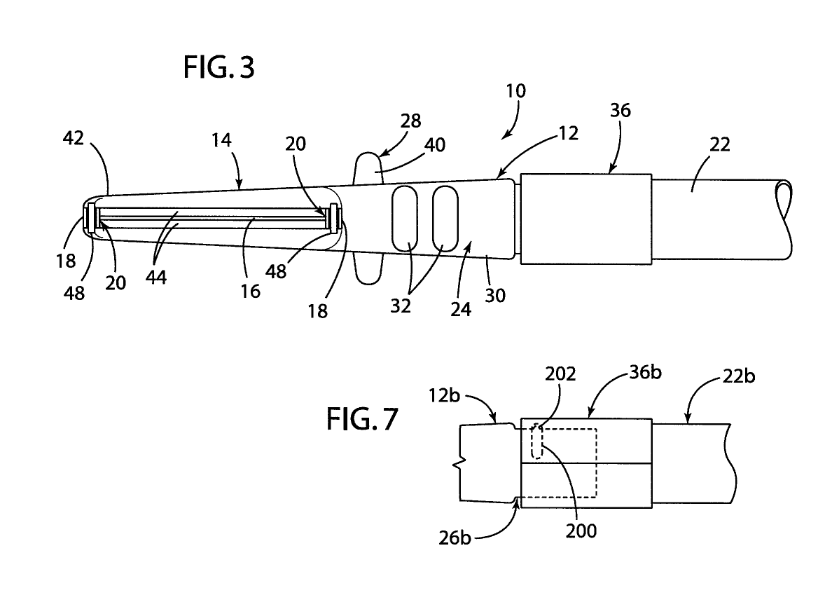

The illustrated air blade 10 includes the handle portion 12 and the blade portion 14. The handle portion 12 comprises a handle grip section 24 with a fitting end 26 and a T-grip section 28. The handle grip section 24 includes a hollow cylinder 30 with a plurality of finger grooves 32 on a bottom thereof. The hollow cylinder 30 is preferably of such a diameter such that a typical person can easily grab and clasp the hollow cylinder 30 with one hand, wherein fingers on the one hand will fit within the finger grooves 32. While two finger grooves 32 are shown, it is contemplated that any number of finger grooves 32 could be employed or eliminated entirely. The hose 22 is connected to the grip section 24 at the fitting end 26. The fitting end 26 includes a smaller diameter section 34 (see FIG. 2) for accepting a collar 36 (see FIG. 3) thereon to secure the air blade 10 to the hose 22. The collar 36 is preferably configured to be rotatably connected to the fitting end 26 to allow the air blade 10 to rotate relative to the hose 22. However, it is contemplated that the hose 22 could be connected to the air blade 10 in any manner and that the air blade 10 could be fixedly connected to the hose 22 (including having the air blade 10 being integral with the hose 22). The T-grip section 28 is adjacent the handle grip section 24 at a location opposite the fitting end 26. The T-grip section 28 includes an angled face 38 on a top of the air blade 10 and a perpendicular projection 40. During use, a second hand of the user of the air blade 10 grabs the perpendicular projection 40 of the T-grip section 28 to hold the air blade 10 and to turn the air blade 10. It is contemplated that the T-grip section 28 could have any configuration (e.g., a doorknob shape). It is further contemplated that an actuator (not shown) (e.g., trigger or button) could extend from the angled face 38 of the T-grip section 28 for activating the source of air to allow air to flow to the air blade 10. The actuator could turn the source of air on or off or just turn the source of air on until a predetermined time period has elapsed (e.g., a momentary contact switch). The actuator can be used to ensure that a user has a proper grip of the air blade 10 before air actuation. It is contemplated that the air blade 10 could have an actuator in any location or not include any actuator. Furthermore, it is contemplated that the actuator could include any switch or button or any other type of trigger.

In the illustrated example, the blade portion 14 is integral with the handle portion 12 of the air blade 10 and is used to supply the forced air to the object. The blade portion 14 includes a pair of side plates 42 with the elongated opening 16 in a bottom thereof between the side plates 42. The top and end of the blade portion 14 are closed to direct the air flowing through the air blade 10 through the elongated opening 16. Bottom ends 44 of the side plates 42 are angled towards each other to form a nozzle for the air blade 10. The projections 18 are connected to each of the side plates 42 at both ends of the elongated opening 16 such that when the blade portion 14 of the air blade 10 is positioned to abut the object, the elongated opening 16 will be spaced from the object. Preferably, the handle portion 12 and the blade portion 14 of the air blade 10 are integrally molded and made of plastic. The handle portion 12 and the blade portion 14 can be made of any material. For example, the handle portion 12 and the blade portion 14 can be made of plastic (e.g., nylon). The projections 18 preferably include pads 46 therein to lessen the impact of the projections 18 against the object to be dried and to allow the air blade 10 to be easily moved over the object. However, it is contemplated that the projections 18 do not have to include any pad 46 or other feature.

The illustrated pad 46 can comprise a disc 48 inserted into a slot 50 in the projections 18. The soft disc 48 can be made of any material. For example, the disc 48 can be made of a soft or a hard material. Therefore, it is contemplated that the disc 48 could be made of a foam or non-marking material. As illustrated in FIG. 2, the disc 48 can include a center opening 52 and a pair of notches 54 in the perimeter of the disc 48. The disc 48 is inserted into the slot 50 such that the notches 54 accept a portion of the material of the projections 18 therein. In the illustrated embodiment, the disc 48 can be connected to the projections using an adhesive. For example, the disc 48 can be connected to the projections 18 using a silicone adhesive. With an adhesive, the center opening 52 assists in allowing the adhesive to flow through the disc 48 to provide a mechanical lock to the disc 48 (with the adhesive drying and adhering to the material of the projections 18 and forming a pin through the disc 48). It is further contemplated that any attachment scheme could be used (e.g., a non-metal, non-marking mechanical fastener such as a plastic rivet or similar one-way, one side fastener). It is also contemplated that the projections 18 could include brushes or bristles instead of the pads 46 or any other non-marking material. FIG. 8 illustrated another configuration of a pad 46d for use with the air blade 10.

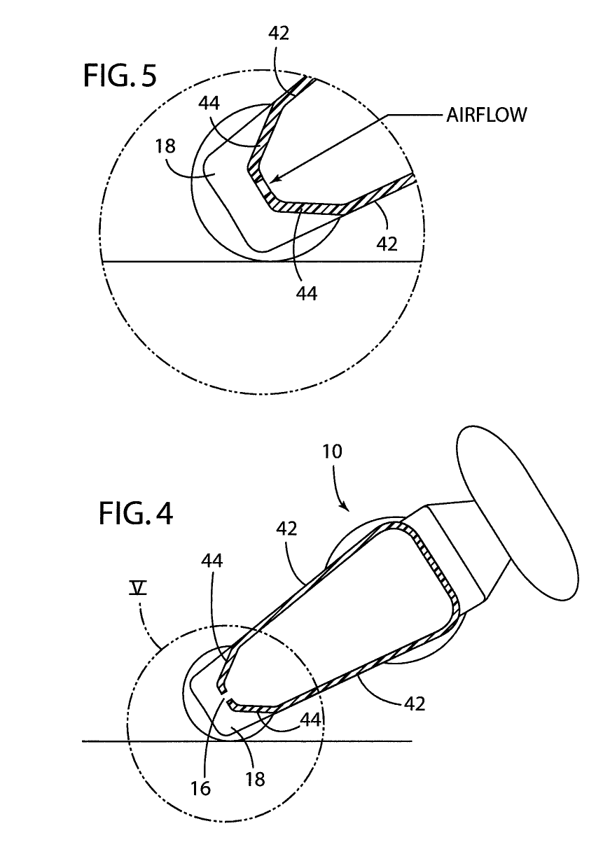

In the illustrated example, it is believed that the spacing of the elongated opening 16 from the object to be dried will assist in drying the object. As shown in FIGS. 4 and 5, the spacing of the elongated opening 16 from the object to be dried because of the projections 18 will force air to be sucked into the flow path of the air exiting the air blade 10 through a venturi effect. Therefore, it is believed that more air will flow over the object, causing the object to be dried quicker. Furthermore, it is believed that having the elongated opening 16 spaced from the object to be dried will help in making a more laminar flow over the object. Moreover, it is believed that a laminar flow over the object to be dried will assist in drying the vehicle.

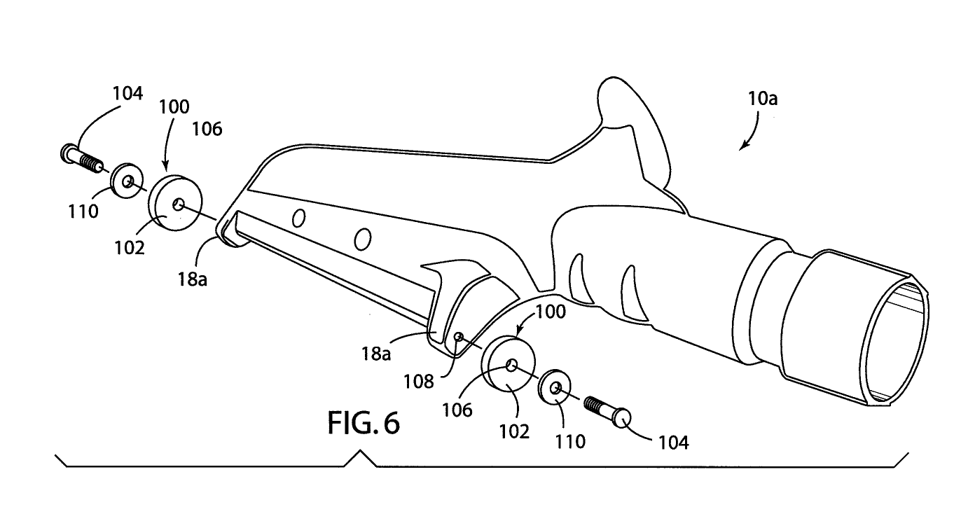

The reference numeral 10a (FIG. 6) generally designates another embodiment of the present invention, having a second embodiment for the air blade. Since air blade 10a is similar to the previously described air blade 10, similar parts appearing in FIGS. 1-5 and FIG. 6, respectively, are represented by the same, corresponding reference number, except for the suffix “a” in the numerals of the latter. The second embodiment of the air blade 10a is identical to the first embodiment of the air blade 10, except that rollers 100 replace the pad 46. As illustrated in FIG. 6, the rollers 100 could comprise a wheel 102 connected to the projections 18a by inserting a fastener 104 through a center opening 106 in the wheel 102 and into an aperture 108 in a side of the projections 18a. It is also contemplated that the wheels 102 could extend into and out of the projections 18a. In the illustrated embodiment, the wheels 102 are made of foam or other soft and non-marking material. Furthermore, a washer 110 made of any material (e.g., nylon) and a non-metallic fastener 104 are used. However, it is contemplated that the wheel 102 and the fastener 104 could be made of any material. Furthermore, it is contemplated that the washer 110 could be omitted from the assembly. The wheel 102 lessens the impact of the projections 18a against the object to be dried and allows the air blade 10a to be easily moved over the object.

The reference numeral 12b (FIG. 7) generally designates a handle portion of another embodiment of the present invention, having a third embodiment for the air blade. Since the handle portion 12b of the third embodiment of the air blade is similar to the previously described handle portion 12 of the air blade 10, similar parts appearing in FIGS. 1-5 and FIG. 7, respectively, are represented by the same, corresponding reference number, except for the suffix “7” in the numerals of the latter. The third embodiment of the air blade, the fitting end 26b is connected to the hose 22b by a collar 38b. The collar 38b is initially a split collar or cuff that is positioned around the fitting end 26b and then the split is glued to lock the collar 38b onto the fitting end 26b. An inside surface of the collar 38b includes a groove 200 and an outside surface of the fitting end 26b includes a plurality of barbs or projections 202. The barbs or projections slide in the groove 200 and allow the collar 38b to rotate relative to the fitting end 26b, but also maintain the fitting end 26b in contact with the collar 38b. It is also contemplated that the collar 38b could be welded or otherwise connected to the hose 22b.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. An air blade comprising:
a handle portion;
a blade portion connected to the handle portion, the blade portion including an elongated opening therein for blowing air out of the air blade onto an object; and
a pair of projections located on each end of the elongated opening and extending outwardly in a direction of the blowing air leaving the air blade such that when the blade portion of the air blade is positioned to abut the object, the elongated opening will be spaced from the object.

2. The air blade of claim 1, wherein:
the handle portion includes handle grip section and a fitting end;
the fitting end is configured to be connected to a hose; and
the handle grip section includes a hollow cylinder with finger grooves on a bottom thereof.

3. The air blade of claim 2, wherein:
the fitting end is tubular and includes a smaller diameter section surrounded by larger diameter sections, the fitting end being configured to accept a collar thereon to secure the air blade to the hose.

4. The air blade of claim 2, wherein:
the fitting end is tubular and includes a plurality of prongs extending radially therefrom for connecting the air blade to a collar of a hose.

5. The air blade of claim 2, wherein:
the handle grip portion includes a T-grip section allowing a user of the air blade to easily grasp the air blade during use.

6. The air blade of claim 1, wherein:
the blade portion includes a pair of side plates with the elongated opening in a bottom thereof between the side plates.

7. The air blade of claim 6, wherein:
bottom ends of the side plates are angled towards each other to form a nozzle for the air blade.

8. The air blade of claim 6, wherein:
the projections include pads therein to lessen an impact of the projections against the object to be dried and to allow the air blade to be easily moved over the object.

9. The air blade of claim 6, wherein:
the projections include rollers for allowing the air blade to roller over the object to be dried and to allow the air blade to be easily moved over the object.

10. An air blade comprising:
a handle portion;
a blade portion connected to the handle portion, the blade portion including an elongated opening therein for blowing air out of the air blade onto an object; and
a pair of projections located on each end of the elongated opening and extending outwardly in a direction of the blowing air leaving the air blade such that when the blade portion of the air blade is positioned to abut the object, the elongated opening will be spaced from the object;
the handle portion including handle grip section and a fitting end, with the fitting end being configured to be connected to a hose and the handle grip section including a hollow cylinder with finger grooves on a bottom thereof;
the handle grip portion including a T-grip section allowing a user of the air blade to easily grasp the air blade during use; and
the blade portion including a pair of side plates with the elongated opening in a bottom thereof between the side plates, with bottom ends of the side plates being angled towards each other to form a nozzle for the air blade.

11. The air blade of claim 10, wherein:
the fitting end is tubular and includes a smaller diameter section surrounded by larger diameter sections, the fitting end being configured to accept a collar thereon to secure the air blade to the hose.

12. The air blade of claim 10, wherein:
the fitting end is tubular and includes a plurality of prongs extending radially therefrom for connecting the air blade to a collar of a hose.

13. The air blade of claim 10, wherein:
the projections include pads therein to lessen an impact of the projections against the object to be dried and to allow the air blade to be easily moved over the object.

14. The air blade of claim 10, wherein:
the projections include rollers for allowing the air blade to roller over the object to be dried and to allow the air blade to be easily moved over the object.

15. A method of drying an object comprising:
providing an air blade comprising a handle portion and a blade portion connected to the handle portion, the blade portion including an elongated opening therein;
providing the air blade with a pair of projections located on each end of the elongated opening and extending outwardly;
positioning the air blade adjacent the object;
abutting the projections against the object;
supplying air to the air blade; and
blowing the air out of the elongated opening of the air blade and onto the object.

16. The method of claim 15, wherein:
the object is a vehicle.

17. The method of claim 15, wherein:
the projections include pads therein to lessen an impact of the projections against the object to be dried and to allow the air blade to be easily moved over the object.

18. The method of claim 15, wherein:
the projections include rollers; and
abutting the projections comprises rolling the rollers over the object.

19. The method of claim 15, further including:
connecting the air blade to a tube supplying air.

20. The method of claim 15, wherein:
the handle portion includes handle grip section and a fitting end, with the fitting end being configured to be connected to a hose and the handle grip section including a hollow cylinder with finger grooves on a bottom thereof;
the handle grip portion includes a T-grip section allowing a user of the air blade to easily grasp the air blade; and
the blade portion including a pair of side plates with the elongated opening in a bottom thereof between the side plates, with bottom ends of the side plates being angled towards each other to form a nozzle for the air blade.
